(19) United States
(12) Patent Application Publication
(10) Pub. No.: US 2010/0273493 A1
(43) Pub. Date: Oct. 28, 2010

(54) RADIO ACCESS NETWORK MANAGEMENT DEVICE, FACILITY PLAN SUPPORT SYSTEM, AND FACILITY PLAN SUPPORT METHOD USED THEREFOR

(75) Inventors: Yasuhiko Matsunaga, Tokyo (JP); Yoshinori Watanabe, Tokyo (JP); Kosei Kobayashi, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 12/747,107

(22) PCT Filed: Dec. 8, 2008
(86) PCT No.: PCT/JP2008/072246

§ 371 Date: Jun. 9, 2010

(30) Foreign Application Priority Data
Dec. 12, 2007 (JP) 2007-320281

(51) Int. Cl. H04W 28/00

(52) U.S. Cl. 455/446

(57) ABSTRACT

A radio access network management device capable of estimating the resource utilization ratio of an additionally installed radio base station to predict the date on which the next additional installation is required. The radio access network management device comprises a means for obtaining traffic demand per unit area for existing radio cells around the position at which a radio base station is additionally installed from the coverage of the existing radio cells and the time series of the past communication traffic statistics, a means for estimating the coverage of the radio cells after the additional installation of the radio base station, a means for predicting the traffic demand of the radio cells after the additional installation thereof from the coverage and traffic demand per unit area, and a means for predicting future communication quality from the predicted traffic demand.

### TECHNICAL FIELD

The present invention relates to a radio access network management apparatus, installing plan support system, and installing plan support method used for them and also its program, especially a support system for installing a new radio base station based on the future prediction of traffic demand regarding the facility configuration management in a mobile communication network.

### BACKGROUND ART

In a mobile communication network, in general, a wide service area is divided into a lot of, what they call, radio cells and a radio base station is installed for around 1 to 10 radio cells. The improvement of the communication quality is performed by adding a new radio base station regarding its necessity, in case of aiming to expand the service area, having shortage of radio circuit capacity or receiving complaints on the communication quality from the subscribers.

In case of installing a new radio base station, in order to have sufficient communication quality, considering geographical features and a building distribution, the adjustment of installing position of a base station and radio parameters (for examples height, direction, and tilt angles of antennas, overhead power lines and so on) is carried out. In general, a radio transmission simulator (a radio transmission characteristics predicting system) is applied as the means to support such an area design. The supporting technique for additionally installing a radio base station with a radio transmission simulator is described in a non-patent document 1 and so on.

And in the patent document 1, the method of making and preparing the advice table is released, which will show what kind of additional installation of facilities and tuning shall be carried out according to the patterns of the deterioration, in case that a radio quality or an operation quality gets worse beyond a threshold value. In this method, proper counter measures which would meet the causes can be taken, because the causes of quality deterioration such as too wide targeted area, shortage of transmitting power supply, too much traffic and so on are judged.

Moreover, in patent document 2, a calculating method to calculate necessary additional installing amount of the communication facilities in future considering the estimation of position depending traffic demand based on the accumulated traffic volume was released.

In the method shown in patent document 2, a service supplying area of telecommunication facilities is divided into no less than two observation unit areas (Tokyo, Chiba, Kanagawa and so on), and the traffic demand of each observation unit area is estimated. In case that the extent of service supplying area of the telecommunication facilities extends over no less than two observation unit area, the traffic demand of each observation unit area is estimated according to the ratio of the area. The future traffic demand is predicted with methods of the regression analysis and so on and necessary amount of the facility can be calculated even if there are any changes in the configuration of telecommunication facilities or the extent of service supplying areas.

Patent document 1: Japanese patent Laid-open publication No. 2003-114911

Patent document 2: Japanese patent Laid-open publication No. 2001-168985

Non-patent document 1: written by Hans Ahnlund, “Radio Network Planning Tools”, Chapter 4 in UMTS Radio Network Planning, Optimization and QOS Management, Kluwer Academic Publishers, pp. 117-145, 2003.

### DISCLOSURE OF THE INVENTION

### Problems to be Solved by the Invention

In the methods for additionally installing a base station relating to the present invention, in case that a radio transmission simulator is applied as shown in the non-patent document 1, it is necessary to estimate the traffic demand in the service area in advance, in order to calculate the communication quality in the service area. It is a problem to estimate the traffic demand around the cover area in case of additionally installing a radio base station, as a radio transmission simulator generally performs a simulation with assuming several patterns of the traffic.

And in the method for additionally installing a base station relating to the present invention, in case of the design supporting method which is described in the patent document 1, a problem of area quality at a certain time of quality evaluation is the object for analysis, therefore it is not clear how long period effects of the improvement will continue in future in case that improving measures for communication quality such as additionally installing facilities and parameter changes are carried out.

Moreover, in the method for additionally installing a base station relating to the present invention, in case of the traffic demand predicting method described in the patent document 2, there is a problem that it cannot be applied in case of expanding a service area with additional installing, as the future traffic demand is predicted only within a range where the service supplying area does not go over the existing observing area. And it is a problem that the error by the unevenness of traffic demand becomes larger in case that users are distributed also in the vertical direction like in a city area, because it is assumed that the traffic is distributed uniformly in a service supplying area in the method.

Therefore the aims of the present invention for solving the above mentioned problems is to provide a radio access network management apparatus, installing plan support system, and installing plan support method used for them and its program which can predict the date when the next additional installation becomes necessary with estimating the resource utilizing rate of the radio base station after additional installation based on the traffic demand according to the cover areas of radio cells in case of expanding a service area with additionally installing a radio base station.

### Means to Solve the Problem

The present invention for solving the above mentioned problems is characterized in comprising: being in a radio access network management apparatus, a calculating means for calculating a traffic demand per a unit area of existing radio cells around the position where a radio base station will be installed additionally, an estimating means for estimating a cover area of each radio cell after an additional installation of the above mentioned radio base station, a predicting means for predicting a traffic demand of each radio cell after an additional installation of the above mentioned radio base station based on the above mentioned cover area and the above mentioned traffic demand per a unit area, and a predicting means for predicting future communication quality based on the predicted traffic demand.

The present invention for solving the above mentioned problems is characterized in comprising: being in an installing plan support system, a calculating means for calculating a traffic demand per a unit area of existing radio cells around the position where a radio base station will be installed additionally, an estimating means for estimating a cover area of each radio cell after an additional installation of the above mentioned radio base station, a predicting means for predicting a traffic demand of each radio cell after an additional installation of the above mentioned radio base station based on the above mentioned cover area and the above mentioned traffic demand per a unit area, and a predicting means for predicting the future communication quality based on the predicted traffic demand.

The present invention for solving the above mentioned problems is characterized in comprising: being in an installing plan support method, a calculating processing for calculating a traffic demand per a unit area of existing radio cells around the position where a radio base station will be installed additionally, an estimating processing for estimating a cover area of each radio cell after an additional installation of the above mentioned radio base station, a predicting processing for predicting a traffic demand of each radio cell after an additional installation of the above mentioned radio base station based on the above mentioned cover area and the above mentioned traffic demand per a unit area, and a predicting processing for predicting the future communication quality based on the predicted traffic demand.

The present invention for solving the above mentioned problems is characterized in being a program loaded in the radio access network management apparatus and that the above mentioned program makes the above mentioned radio access network management apparatus executes: a calculating processing for calculating a traffic demand per a unit area of existing radio cells around the position where a radio base station will be installed additionally, an estimating processing for estimating a cover area of each radio cell after an additional installation of the above mentioned radio base station, a predicting processing for predicting a traffic demand of each radio cell after an additional installation of the above mentioned radio base station based on the above mentioned cover area and the above mentioned traffic demand per a unit area, and a predicting processing for predicting the future communication quality based on the predicted traffic demand.

### EFFECTS OF THE INVENTION

The present invention provides an effect to make it possible with the above mentioned configuration and operation to predict the date when the next additional installation becomes necessary with estimating the resource utilizing rate of the radio base station after the additional installation based on the traffic demand according to the cover areas of radio cells in case of expanding a service area with additionally installing a radio base station.

### BRIEF DESCRIPTION OF THE DRAWINGS

FIG. 1 is a block diagram illustrating a configuration of a radio access network management apparatus of the first embodiment of the present invention.

FIG. 2 is a diagram illustrating a network configuration before additionally installing a radio base station in the first embodiment of the present invention.

FIG. 3 is a diagram illustrating a network configuration after additionally installing a radio base station in the first embodiment of the present invention.

FIG. 4 is a diagram illustrating an inner configuration of a radio area information storage unit in FIG. 1.

FIG. 5 is a diagram illustrating an inner information configuration of a traffic demand storage unit in FIG. 1.

FIG. 6 is a flow chart illustrating a traffic demand predicting operation of the first embodiment of the present invention.

FIG. 7 is a graph illustrating a traffic demand predicting operation of the first embodiment of the present invention.

FIG. 8 is a block diagram illustrating a configuration of a radio access network management apparatus of the second embodiment of the present invention.

FIG. 9 is a flow chart illustrating a traffic demand predicting operation of the second embodiment of the present invention.

FIG. 10 is a diagram illustrating an inner configuration of a radio area information storage unit in the third embodiment of the present invention.

### EXPLANATION OF SYMBOLS

1, 2, 3 existing radio cell
n new radio cell
10 radio base station (existing)
11 radio base station (new)
20 to 23 cable link
30 radio base control station
40 core network
50, 60 radio access network management apparatus
51 data transmitting/receiving unit
52 failure management unit
53 quality monitoring unit
54 configuration management unit
55 traffic demand storage unit
56 radio area information storage unit
57 traffic demand predicting unit
58 information input unit of an additionally installed base station
59 display unit
61 future population predicting unit
70 radio wave transmitting simulator
100 position of an additionally installed base station
200 to 300, 310 to 316 base station identifier
210 to 213, 320 to 326 radio cell identifier
220 to 223 radio cell center longitude (Xi)
230 to 233 radio cell center latitude (Yi)
240 to 243 radio cell cover area space (Si)
250 to 253 building area space in a cell (Vi)
260 to 263 total building floor space in a cell (Wi)
270 to 273 revised radio cell cover area space (Si*)
300 to 306 date and time information
330 to 336 radio cell traffic

### BEST MODE FOR EXECUTING THE PRESENT INVENTION

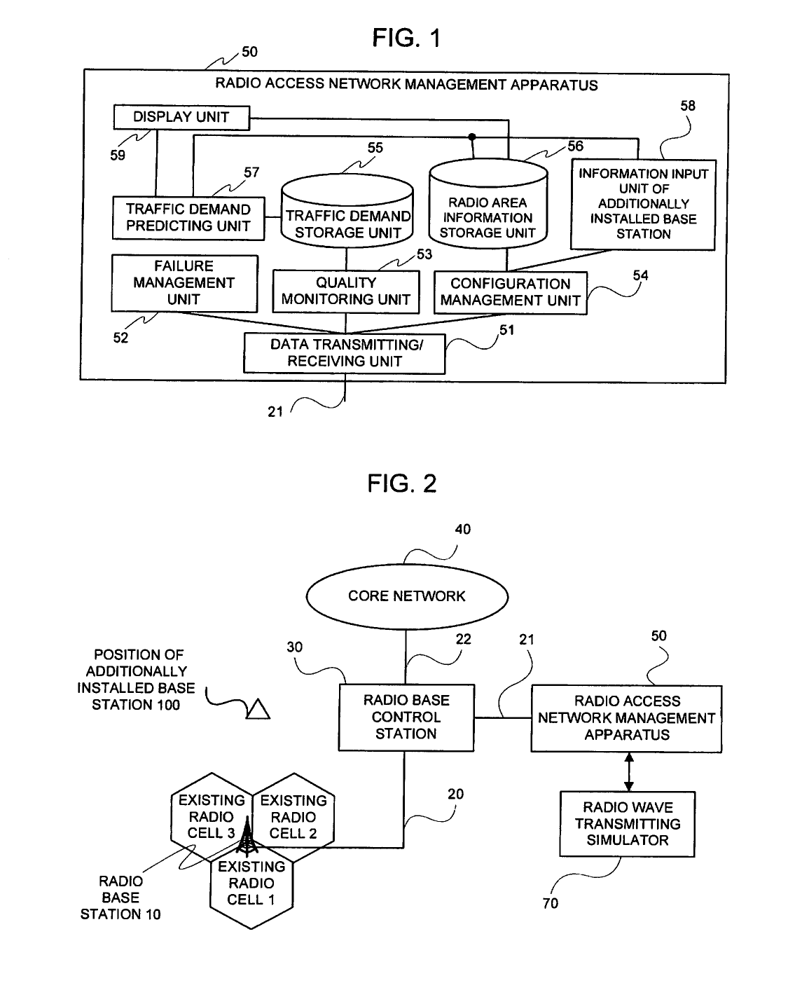

Next, an embodiment of the present invention is explained by referring to several diagrams. FIG. 1 is a block diagram illustrating a configuration of a radio access network management apparatus of the first embodiment of the present invention. In FIG. 1, a radio access network management apparatus 50 is comprised of a data transmitting/receiving unit 51, a failure management unit 52, a quality monitoring unit 53, a configuration management unit 54, a traffic demand storage unit 55, a radio area information storage unit 56, a traffic demand predicting unit 57, an information input unit of an additionally installed base station 58, and a display unit 59.

Further explaining, in a radio access network management apparatus 50, each of a failure management unit 52, a quality monitoring unit 53, a configuration management unit 54, and a traffic demand predicting unit 57 can be realized by executing the program in each of CPUs (Central Processing Units) (not shown in the diagram).

FIG. 2 is a diagram illustrating a network configuration before additionally installing a radio base station in the first embodiment of the present invention. In FIG. 2, the part except a core network 40 shows a radio access network.

An existing radio base station 10, of which the cover area consists of three cells of radio cell 1, 2 and 3, is connected to a radio base control station 30 via a cable link 20. And the radio base control station 30 is connected to a core network 40 via a cable link 22 and carries out the control of its radio base station 10 and the data transfer processing between the core network 40 and itself.

A radio access network management apparatus 50 is connected to a radio base control station 30 via a cable link 20, and carries out the quality monitoring, the failure management and the configuration management of each of radio cell 1, 2, and 3. And the radio access network management apparatus 50 gets the information such as cover area space of radio cell 1, 2, and 3 from a radio wave transmitting simulator 70.

Next, in this network, it is assumed to install an additional new radio base station at a position of an additionally installed base station 100. The following cases are considered to be the opportunity for the additional installation, the case that the resource utilizing rate of existing radio cells goes over a threshold value the case that complaints on the communication quality problems from users are accepted, the case that a new traffic demand is expected because a new building is constructed at a position of an additionally installed base station.

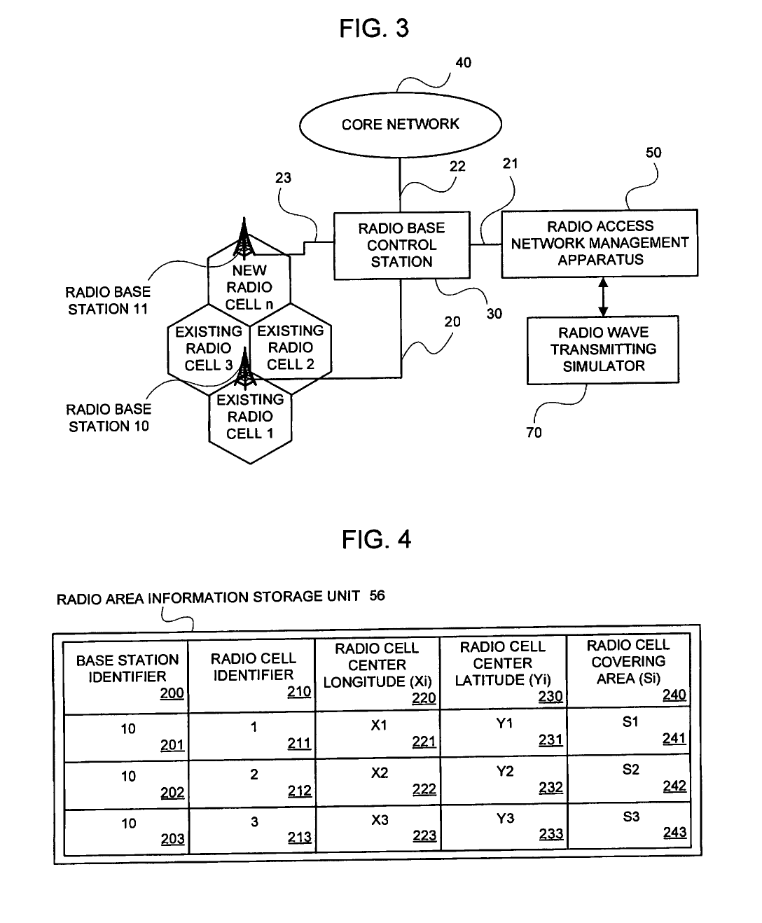

FIG. 3 is a diagram illustrating a network configuration after additionally installing a radio base station in the first embodiment of the present invention. FIG. 3 is illustrating a network configuration after additionally installing a radio base station 11.

The radio base station 11, of which the covering extent consists of new radio cells n, is connected to a radio base control station 30 via a cable link 23. The other configuration is as same as the network configuration shown in the above mentioned FIG. 2.

Referring to FIG. 1 to FIG. 3, the explanation of the radio access network management apparatus 50 is as follows.

A data transmitting/receiving unit 51 collects network monitoring data from a radio access network via a cable link 21. A failure management unit 52 processes failure messages generated when failures occur in radio base stations 10 and 11, a radio base control station 30, or cable links 20 to 23.

A quality monitoring unit 53 processes inputted monitoring data on the communication quality of each of radio cells 1, 2, 3, n and cable links 20 to 23. Among them, statistic information on the traffic demand is outputted to a traffic demand storage unit 55 and it stores traffic demand information of a past certain period in order to predict the traffic demand.

A configuration management unit 54 manages the network configuration of a radio access network and stores the configuration information of radio base stations 10 and 11 and radio cells 1, 2, 3 and n, the position information (longitude and latitude), the covering extent and so on in a radio area information storage unit 56. An information input unit of an additionally installed base station 58 inputs the information of radio base stations 10 and 11 which are objects of additional installation by means of a keyboard, a mouse or so on and gets the covering extent information and so on of the radio cell n which is newly added via a radio wave transmitting simulator 70.

A traffic demand predicting unit 57 predicts the future traffic demand of existing radio cells 1, 2, and 3 and a new radio cell n based on the radio area information of existing radio cells 1, 2, and 3 and a new radio cell n and the past traffic demand of existing radio cells 1, 2, and 3. And the traffic demand predicting unit 57 predicts the future resource utilizing rate of each of radio cells 1, 2, 3 and n based on the predicted traffic demand and outputs the date when the next additional installation becomes necessary to a display unit 59.

Although a quality monitoring unit 53 and a configuration management unit 54 manage other than traffic demand and radio area information, the explanation of them is omitted because it is not directly related to the present invention and the functions which are not related to the additional installation of facilities in radio base stations are known well by the traders concerned.

FIG. 4 is a diagram illustrating an inner configuration of a radio area information storage unit 56 in FIG. 1. In FIG. 4, the radio area information storage unit 56 holds a base station identifier column 200, a radio cell identifier column 210, a radio cell center longitude (Xi) column 220, a radio cell center latitude (Yi) column 230, and a radio cell cover area space (Si) column 240.

The base station identifier column 200 holds the radio base station identifiers 201, 202 and 203 which are existing in the radio access network which is a managing object of the radio access network management apparatus 50. The radio cell identifier column 210 holds radio cell identifiers 211, 212 and 213 which are managing objects of it.

The column 220 of a radio cell center longitude Xi and the column 230 of a radio cell center latitude Yi show the longitude and the latitude of the center of the each radio cell. The column 240 of a radio cell cover area space Si manages the extent of the ground surface area covered by each radio cell. The information of the longitude and the latitude of the center points of radio cells and the cover area space of radio cells is gotten with estimating the shape of radio cells with a radio wave transmitting simulator 70.

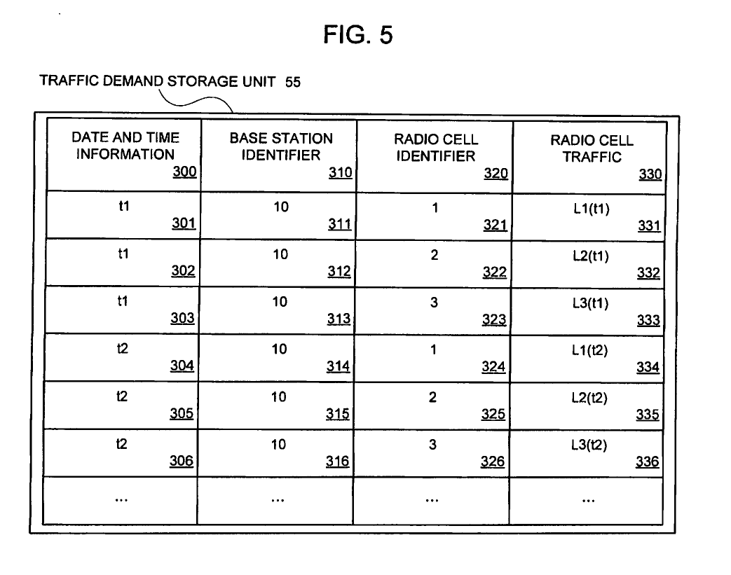

FIG. 5 is a diagram illustrating an inner information configuration of a traffic demand storage unit 55 in FIG. 1. In FIG. 5, the traffic demand storage unit 55 stores traffic statistic values of enough period of the past to predict the traffic demand, that is to say, a date and time information column 300, a base station identifier column 310, a radio cell identifier column 320, and a radio cell traffic column 330.

The date and time information column 300 indicates the past date and time 301, 302, . . . , 306 when the traffic demand was measured. The base station identifier column 310 and the radio cell identifier column 320 are identifiers of the radio base stations and the radio cells and the traffic demand of the radio cell which is specified by the combination of them at a point in the past is stored in the radio cell traffic column 330.

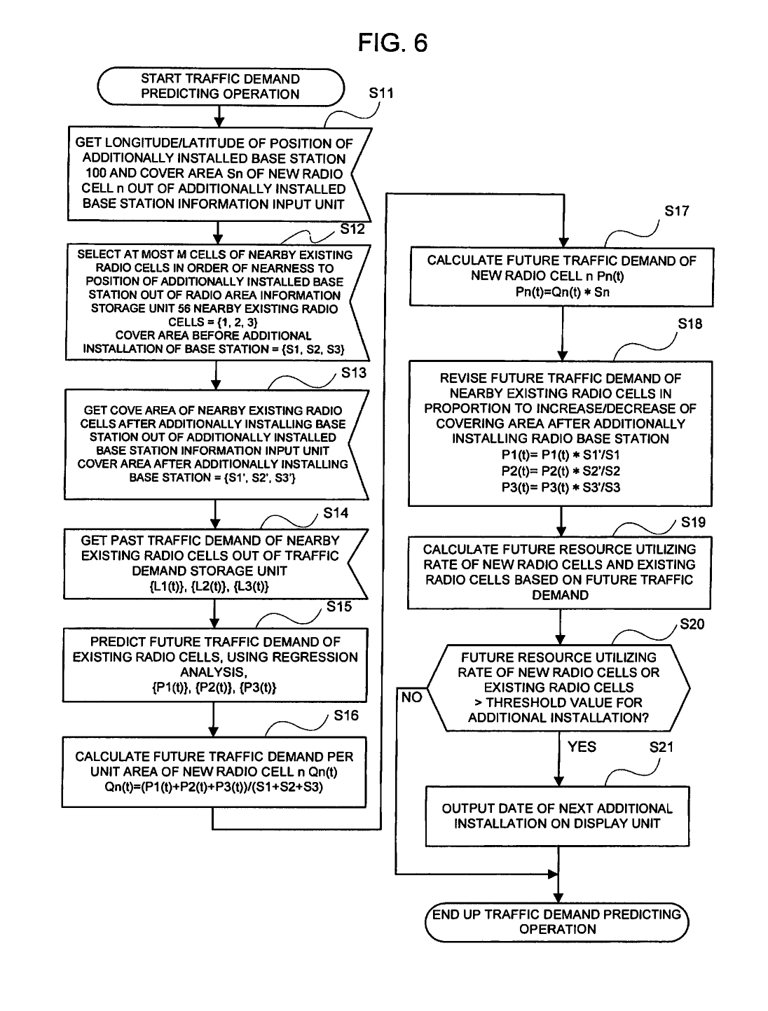

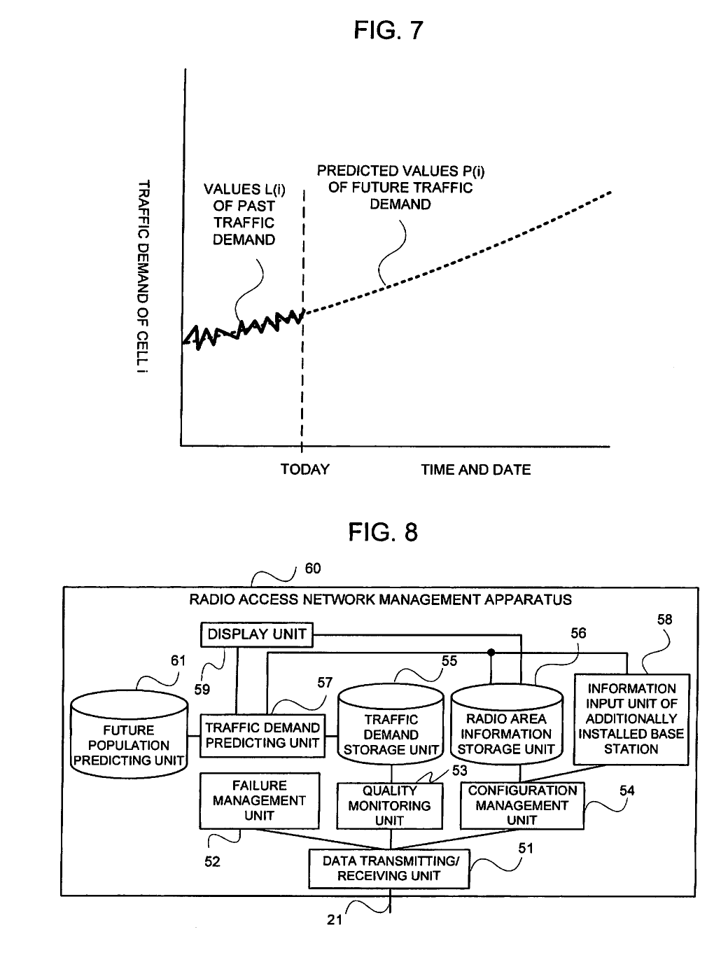

FIG. 6 is a flow chart illustrating a traffic demand predicting operation of the first embodiment of the present invention. FIG. 7 is a graph illustrating a traffic demand predicting operation of the first embodiment of the present invention. Referring to FIG. 1 to FIG. 7, the traffic demand predicting operation of the first embodiment of the present invention is explained as follows. Further explaining, the operation shown in FIG. 6 is realized as a CPU carries out a program in a radio access network management apparatus 50 in FIG. 1.

A traffic demand predicting unit 57 of the radio access network management apparatus 50, after starting the predicting operation, gets the longitude and the latitude of a position of an additionally installed base station 100 and a cover area Sn of a new radio cell n which corresponds to an additionally installed radio base station 11 from an information input unit of an additionally installed base station 58 (Step S11 in FIG. 6).

The traffic demand predicting unit 57 selects at most M cells of nearby existing radio cells in order of nearness to the position of an additionally installed base station out of a radio area information storage unit 56 (Step S12 in FIG. 6). It is carried out with calculating the distance between the two positions based on the longitude and the latitude of the position of an additionally installed base station and the longitude and the latitude of the center of the existing radio cell. In the embodiment of the present invention, in case that three of radio cells 1, 2 and 3 are selected as the existing cells nearby, the cover area spaces {S1, S2, S3} before the additional installation of a radio base station, which are corresponding to each of radio cell 1, 2 and 3 are gotten.

Next, the traffic demand predicting unit 57 gets the cover area space of nearby existing radio cells after additionally installing a radio base station from the information input unit of an additionally installed base station 58 (Step S13 in FIG. 6). In the embodiment of the present invention, the cover area spaces of nearby existing radio cells 1, 2, and 3 are changed to {S1′, S2′, S3′} after additionally installing a base station.

Continuing to the above mentioning, the traffic demand predicting unit 57 gets the time series information of the past traffic demand of nearby existing radio cells from a traffic demand storage unit 55 (Step S14 in FIG. 6).

The time series of the past traffic demand of existing radio cells 1, 2 and 3 are {L1(t)}, {L2(t)} and {L3(t)}. And future traffic demand of existing radio cells is predicted with using general time series predicting methods such as the regression analysis and so on, the time series of the future traffic demand of existing radio cells 1, 2 and 3 are {P1(t)}, {P2(t)} and {P3(t)} (Step S15 in FIG. 6). The relation between the past values L(i) of cell i actually measured until today and the predicted values P(i) of the future traffic demand is shown in FIG. 7.

The future traffic demand per a unit area space of a new radio cell n Qn(t) is calculated with dividing the future traffic demand of nearby existing radio cells by the cover area space of the cells (Step S16 in FIG. 6). In this example, the future traffic demand per a unit area space of a new radio cell n Qn(t) is calculated as follows;

Qn(t)=[P1(t)+P2(t)+P3(t)]/[S1+S2+S3] (1)

The future traffic demand of a new radio cell n Pn(t) can be predicted with multiplying the future traffic demand per a unit area space of a new radio cell n Qn(t) by the cover area space of the newly installed radio cell n Sn as indicated in the following equation (Step S17 in FIG. 6).

Pn(t)=Qn(t)*Sn (2)

And the traffic demand predicting unit 57 revises the future traffic demand of nearby existing radio cells in proportion to the increase or decrease of cover area space after additionally installing a radio base station (Step S18 in FIG. 6). In case of assuming that the traffic is uniformly distributed in the cover area, the future traffic demand after additionally installing a base station can be predicted as indicated in the following equation.

P1(t)=P1(t)*S1′/S1

P2(t)=P2(t)*S2′/S2

P3(t)=P3(t)*S3′/S3 (3)

At this point, the traffic demand predicting unit 57 calculates the future resource utilizing rate of new radio cells and existing radio cells based on the predicted future traffic demand (Step S19 in FIG. 6). The traffic demand predicting unit 57 calculates the time and date when the future resource utilizing rate of new radio cells or existing radio cells goes over the threshold value which indicates the necessity of the additional installation (Step S20 in FIG. 6), and outputs the date of the next additional installation on a display unit 59, in case that there is a time and date when it goes over the threshold value during the predicting period (Step S21 in FIG. 6).

After completing the above mentioned processing, the radio access network management apparatus 50 ends up its predicting operation.

In this way, in the embodiment of the present invention, it is configured that the future traffic demand and the resource utilizing rate of a new radio cell n are predicted based on a long period trend of traffic volume per a unit area space calculated out of the cover area space of nearby existing radio cells 1, 2, and 3 and the past statistic of communication traffic regarding the position where additionally installing a radio base station 11.

Therefore in the embodiment of the present invention, the date when the next additional installation becomes necessary can be predicted based on the change of resource utilizing rate after additionally installing a radio base station 11. Therefore, the effect continuing period of the quality improvement by the additional installation can be calculated as an effect in the embodiment of the present invention.

FIG. 8 is a block diagram illustrating a configuration of a radio access network management apparatus of the second embodiment of the present invention. In FIG. 8, the configuration of the second embodiment of the present invention is as same as the configuration of the radio access network management apparatus 50 of the first embodiment of the present invention illustrated in FIG. 1 other than that a future population predicting unit 61 is installed in a radio access network management apparatus 60 and the future population predicting unit 61 is used to predict the traffic demand of new radio cells, and same symbols are marked on the same components. And the operation of the same components is as same as that of the first embodiment of the present invention.

The future population predicting unit 61 is realized with referring to a future population predicted data base per each of cities, towns and villages, which is provided generally by administrative organs.

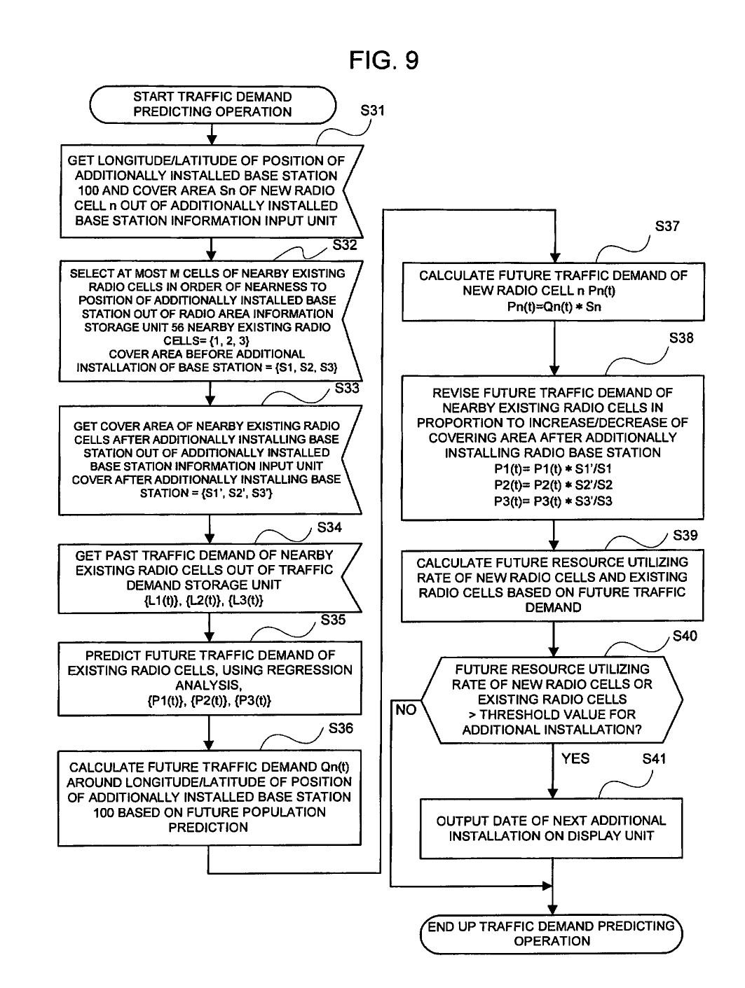

FIG. 9 is a flow chart illustrating a traffic demand predicting operation of the second embodiment of the present invention. Further explaining, in FIG. 9, the operation of Step S31 to S35 and the operation of Step S37 to S41 are as same as the traffic demand predicting operation of Step S11 to S15 and Step S17 to S21 in the above mentioned first embodiment of the present invention.

The traffic demand predicting operation of the second embodiment of the present invention is explained as follows referring to these FIG. 8 and FIG. 9. The operation illustrated in FIG. 9 is realized as a CPU executes the program in the radio access network management apparatus 60 in FIG. 6.

The traffic demand predicting unit 57 of the radio access network management apparatus 60 calculates the future traffic demand Qn(t) around the longitude and latitude of a position of an additionally installed base station and calculates the future traffic demand of radio cells covered by a new base station based on it (Step S36 in FIG. 8).

It is an example to calculate the traffic demand per a unit area space out of the future population predicted data base stored in the future population predicting unit 61 to multiply the subscriber rate per each age group of mobile communication service providers of all over the country by future population per a unit area space for each age group in the concerned area (the cover area of nearby existing radio cells around the radio base station to be installed additionally) and divide it by the concerned area space.

Therefore in the embodiment of the present invention, using the future population predicted data instead of using the past traffic statistic of nearby radio cells, it becomes possible to install additional facilities for a radio base station based on the estimation of future traffic demand, even though the area whose service area to be expanded is located far from existing radio cells or it is predicted that the traffic demand is much different from that of nearby existing radio cells.

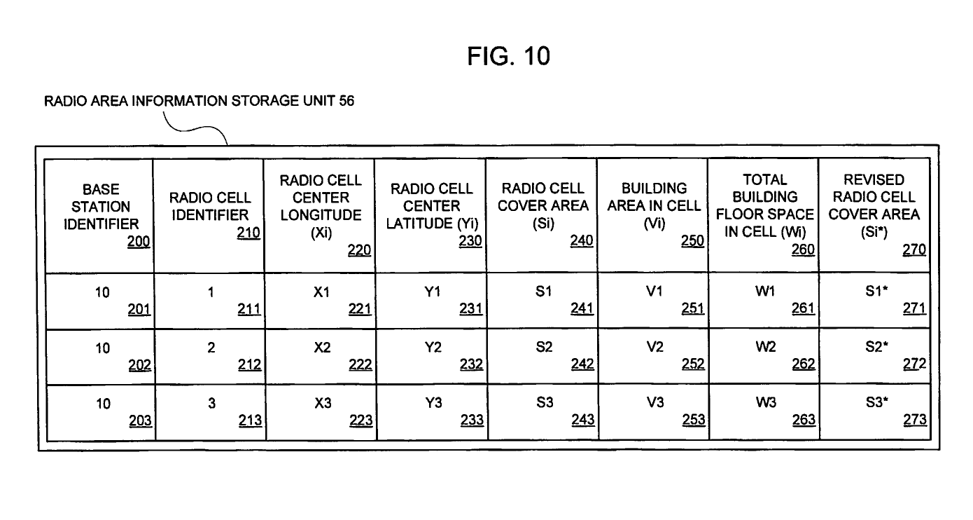

FIG. 10 is a diagram illustrating an inner configuration of a radio area information storage unit 56 in the third embodiment of the present invention. In FIG. 10, the radio area information storage unit 56 stores a building area space in a cell column Vi 250, a total building floor space in a cell column Wi 260 and a revised radio cell cover area space column Si* 270 in addition to the configuration of the radio area information storage unit 56 in the first embodiment of the present invention illustrated in FIG. 4.

In the embodiment of the present invention, considering that the traffic demand is not distributed uniformly on the ground surface but assuming that it is also distributed in the vertical direction in proportion to the building floor space, a building area space in a cell column Vi 250, a building floor space in a cell column Wi 260 and a revised radio cell cover area space column Si* 270 are added to the radio area information storage unit 56.

The building area space in a cell Vi is calculated with adding all the base area space after extracting the information of all the structures which are existing in the radio cell covering extent out of digital maps. And the building floor space in a cell Wi is calculated with multiplying the floor quantity information of each structure by the base area space and adding them up after extracting the information of all the structures which are existing in the radio cell covering extent out of digital maps. The revised radio cell cover area space Si* is calculated with the following equation;

Si*=Si+(Wi−Vi) (4)

In the embodiment, using the revised radio cell cover area space Si* instead of Si and carrying out the predicting operation of future traffic demand in the first embodiment of the present invention or in the second embodiment of the present invention, the effect of the additional installation of the radio base station can be estimated accurately with predicting the future traffic even in case that many users are distributed in the vertical direction.

As above mentioned, the present invention, comprising; a input means for inputting time series of the past traffic statistics of radio cells or future population predicted values around the position of the radio base station to be installed additionally, a predicting means of predicting the future value of the traffic demand per a unit area space at the position where a radio base station will be installed additionally, a estimating means for estimating the cover area of new radio cells and existing radio cells after additional installation of a radio base station, and a predicting means for predicting the future resource utilizing rate in new radio cells and existing radio cells according to the future value of predicted traffic demand, operates to calculate the date when the next additional installation of facility becomes necessary based on the predicted value of the future resource utilizing rate.

And other example of the present invention comprises an inputting means for inputting building information in the cover area of existing radio cells, and a predicting means for predicting a future traffic demand value per a unit area space at the position of additionally installing a radio base station with applying the cover area space normalized with the floor space of each building.

The present invention will give the following effects with adopting the above mentioned configuration, estimating the traffic demand around the area where a radio base station will be installed additionally and predicting the change of resource utilizing rate of today and future.

The first effect of the present invention is to make it possible to predict the date when the next additional installation becomes necessary based on the prediction of the resource utilizing rate of the additionally installed radio base station in case of expanding a service supplying area with an additional installation of a radio base station. The cause of it is that it is possible to predict the future resource utilizing rate in case that the shape of a radio cell is changed and even in case of additionally installing a radio base station at the position where has not been a service supplying area before according to the estimation of the future traffic demand per a unit area space around the area where a radio base station will be installed additionally.

And the second effect of the present invention is to make it possible to predict the change of future resource utilizing rate even in case that a radio base station is installed additionally in the area which is not adjoining to any existing service areas. The cause is to estimate the future traffic demand based on the future population estimation instead of the past traffic demand nearby area in case that a radio base station is installed additionally in the area which is not adjoining to any existing service areas.

Moreover the third effect of the present invention is to make it possible to predict the future traffic demand accurately even in such surroundings as of cities and towns where users are distributed in the vertical direction. The cause is to use the cover area space normalized with the floor space of each building in order to estimate the future traffic demand.

### [Possible Applications in Industry]

The present invention can be applied to such a use as an installing planning to study the additional installation of a radio base station in a mobile communication network. And the present invention can be applied to the quality watchdog of telecommunication because it estimates the future resource utilizing rate in a radio cell or a radio base station.

The present application claims the priority right based on Japanese Patent application No. 2007-320281 filed on Dec. 12, 2007 and the entire of the disclosure is incorporated here.

1. A radio access network management apparatus, comprising:
a calculator for calculating a traffic demand per a unit area of existing radio cells around a position where a radio base station will be installed additionally;
an estimating unit for estimating a cover area of each radio cell after said additional installation of said radio base station;
a predicting unit for predicting a traffic demand of each radio cell after said additional installation of said radio base station based on said cover area and said traffic demand per a unit area; and
a predicting unit for predicting a future communication quality based on the predicted traffic demand.

2. A radio access network management apparatus according to claim 1, wherein said traffic demand per a unit area is calculated based on said cover area of existing radio cells and time-series of a past communication traffic statistic.

3. A radio access network management apparatus according to claim 1, wherein said traffic demand per a unit area is calculated based on said cover area of existing radio cells and a population predicted value of said cover area of existing radio cells.

4. A radio access network management apparatus according to claim 1, wherein said cover area of each radio cell is calculated in proportion to a building floor space in the concerned area.

5. An installing plan support system, comprising:
a calculator for calculating a traffic demand of existing radio cells per a unit area around the position where a radio base station will be installed additionally;
an estimating unit for estimating a cover area of each radio cell after said additional installation of said radio base station;
a predicting unit for predicting a traffic demand of each radio cell after said additional installation of said radio base station based on said cover area and said traffic demand per a unit area; and
a predicting unit for predicting the future communication quality based on the predicted traffic demand.

6. A facility plan support method, said method comprising the steps of:
for calculating a traffic demand per a unit area of existing radio cells around a position where a radio base station will be installed additionally;
estimating a cover area of each radio cell after said additional installation of said radio base station;
predicting a traffic demand of each radio cell after said additional installation of said radio base station based on said cover area and said traffic demand per a unit area; and
predicting the future communication quality based on the predicted traffic demand.

7. An installing plan support method according to claim 6, wherein said traffic demand per a unit area is calculated based on a cover area of said existing radio cells and time-series of a past communication traffic statistic.

8. An installing plan support method according to claim 6, wherein said traffic demand per a unit area is calculated based on a cover area of said existing radio cells and a population predicted value of a cover area of said existing radio cells.

9. An installing plan support method according to claim 6, wherein said cover area of each radio cell is calculated in proportion to a building floor space in the concerned area.

10. A program for a radio access network management apparatus, wherein said program makes said radio access network management apparatus execute:
a calculating processing for calculating a traffic demand per a unit area of existing radio cells around the position where a radio base station will be installed additionally;
an estimating processing for estimating a cover area of each radio cell after an additional installation of said radio base station;
a predicting processing for predicting a traffic demand of each radio cell after an additional installation of said radio base station based on said cover area and said traffic demand per a unit area; and
a predicting processing for predicting a future communication quality based on the predicted traffic demand.

11. A radio access network management apparatus according to claim 2, wherein said cover area of each radio cell is calculated in proportion to a building floor space in the concerned area.

12. A radio access network management apparatus according to claim 3, wherein said cover area of each radio cell is calculated in proportion to a building floor space in the concerned area.

13. An installing plan support method according to claim 7, wherein said cover area of each radio cell is calculated in proportion to a building floor space in the concerned area.

14. An installing plan support method according to claim 8, wherein said cover area of each radio cell is calculated in proportion to a building floor space in the concerned area.
